(19) United States
(12) Patent Application Publication
(10) Pub. No.: US 2013/0199455 A1
(43) Pub. Date: Aug. 8, 2013

(54) Containment structure for septic pits

(71) Applicant: Damien Ross, St-Mathieu-de-Beloeil (CA)

(72) Inventor: Damien Ross, St-Mathieu-de-Beloeil (CA)

(21) Appl. No.: 13/573,064

(22) Filed: Aug. 17, 2012

(30) Foreign Application Priority Data
Aug. 19, 2011 (CA) 2,752,165

(51) Int. Cl. A01K 29/00

(52) U.S. Cl. CPC A01K 29/00
USPC 119/165

(57) ABSTRACT

A containment structure for a septic pit for manure, the septic having a side wall extending upwardly from a bottom wall, the containment structure including a base designed to sit on the side wall of the septic pit, a frame extending over the septic pit, an upper connecting device hanging from a flexible cable interconnecting the upper connecting device and the frame, a plurality of lower attachment members and a plurality of straps extending between the upper connecting device and the lower attachment members with a cover being supported by the straps.

### FIELD OF THE INVENTION

The present invention relates to a containment structure and more particularly, relates to a containment structure suitable for use with septic pits such as may be used for animal manure.

### BACKGROUND OF THE INVENTION

The storage and disposal of liquid manure has always presented a problem to the agricultural industry. Since the liquid manure ordinarily cannot be used as a fertilizer without further treatment, it is usually stored by the farmer in a manure septic pit. As the size of farms increases, there may be a plurality of such septic pits required.

Frequently, the liquid manure is transported to a central facility where it is treated before disposal of the same. In this regard, the liquid manure is the source of objectionable odours. Apart from the general nature of the disagreeable odour, the manure pits also present a hazard to humans. Inside the manure pit, the manure undergoes anaerobic digestive fermentation to form fertilizer. During the digestive process, potentially dangerous gases such as methane, oxygen sulfide, carbon dioxide and ammonia are generated. Frequently farm workers will enter the area of a manure pit and die from asphyxiation. Also, some of the gases present a fire hazard and explosions have been known to happen.

The typical manure pit on a farm is formed of a concrete material and is cylindrical in configuration.

### SUMMARY OF THE INVENTION

It is an object of the present invention to provide for a containment structure for manure pits to eliminate the odour problem associated therewith.

According to one aspect of the present invention, there is provided a containment structure for a septic pit for manure, the septic pit having a side wall extending upwardly from a bottom wall, the containment structure comprising a base designed to sit on the sidewall of the septic pit, a frame extending over the septic pit, an upper connecting device, the upper connecting device hanging from a flexible cable interconnecting the upper connecting device and the frame, a plurality of lower attachment members, a plurality of straps extending between the upper connecting device and the lower attachment members, and a cover extending over the septic tank, the cover being supported by the straps.

The containment structure described above has several advantages. Initially, the use of a flexible attachment permits one to have a containment structure which will tend to shed any snow load. With the movement of any wind, the snow will tend to fall off the structure. Accordingly, typical reinforcements for snow loads are not required.

In a preferred embodiment, the containment structure is provided with a “chimney” which will permit the egress of gases. These gases, particularly methane, can be used to generate power and/or heat for use at the location. If there are many such structures, the methane could be used to generate electricity. Alternatively, the methane could be used to heat some of the surrounding buildings.

The cover may be formed of any suitable material and is preferably formed of a plastic material selected from those well known in the art. It would have a thickness designed to withstand any damage thereto.

In a preferred embodiment, the straps are the structural member which supports the cover. The straps will extend from the upper connecting device to a lower strap attachment member which is secured to the wall of the septic pit. Preferably, a winch is provided for

Would the Office kindly amend the Brief Description of the Drawings on page 3 of the Disclosure as follows:

### BRIEF DESCRIPTION OF THE DRAWINGS

Having thus generally set forth the aims of the invention, reference will now be made to the accompanying drawings illustrating an embodiment thereof, in which:

FIG. 1A is a side elevational view of a containment structure according to one embodiment of the present invention;

FIGS. 1B, 1C, 1D and 1E are side views of certain elements of the structure seen in FIG. 1;

FIG. 2 is a perspective view of the top structure supporting the cover;

FIG. 3 is a side elevational view thereof;

FIG. 4A shows an upper portion of the truss;

FIG. 4B is an enlarged view of the plate member of FIG. 4A;

FIG. 5A is a side elevational view seen from the right hand side of FIG. 1;

FIG. 5B is an enlarged view of the upper portion of the cover;

FIG. 5C is an enlarged view of the bracket on the side of the septic pit;

FIG. 6 illustrates various views of the components of the cover structure; and

FIG. 7 is a cross sectional view of a strap structure.

### DETAILED DESCRIPTION OF THE INVENTION

Referring to the drawings in greater detail and by reference characters thereto, there is illustrated a manure pit generally designated by reference numeral 4 and which manure pit is generally circular in configuration and has a manure pit side wall 6 and a manure pit top wall 8.

The containment structure of the present invention is generally designated by reference numeral 10 and includes a truss 12 which is of the so called Pratt type. The truss is made up of various sections secured together and to this end, there is provided a top section generally designated by reference numeral 14 and which has a bottom chord 16, a top chord 18 and diagonally extending members 20.

There are provided two end sections for truss 12, the end sections being generally designated by reference numerals 22, 22′. Each of the end sections has a top chord 24, 24′ and a bottom chord 26, 26′ along with a plurality of diagonal members 28, 28′ extending therebetween.

It will be noted that each of top section 14 and end sections 22, 22′ have a somewhat arcuate configuration.

Extending between top section 14 and end sections 22, 22′ are intermediate sections 30, 30′ with each having a top chord 32, 32′ and a bottom chord 34, 34′. A plurality of diagonal members 36, 36′ extend between the top and bottom chords.

Secured to top truss section 14 are plate members 38 which are designed to retain a pulley 40.

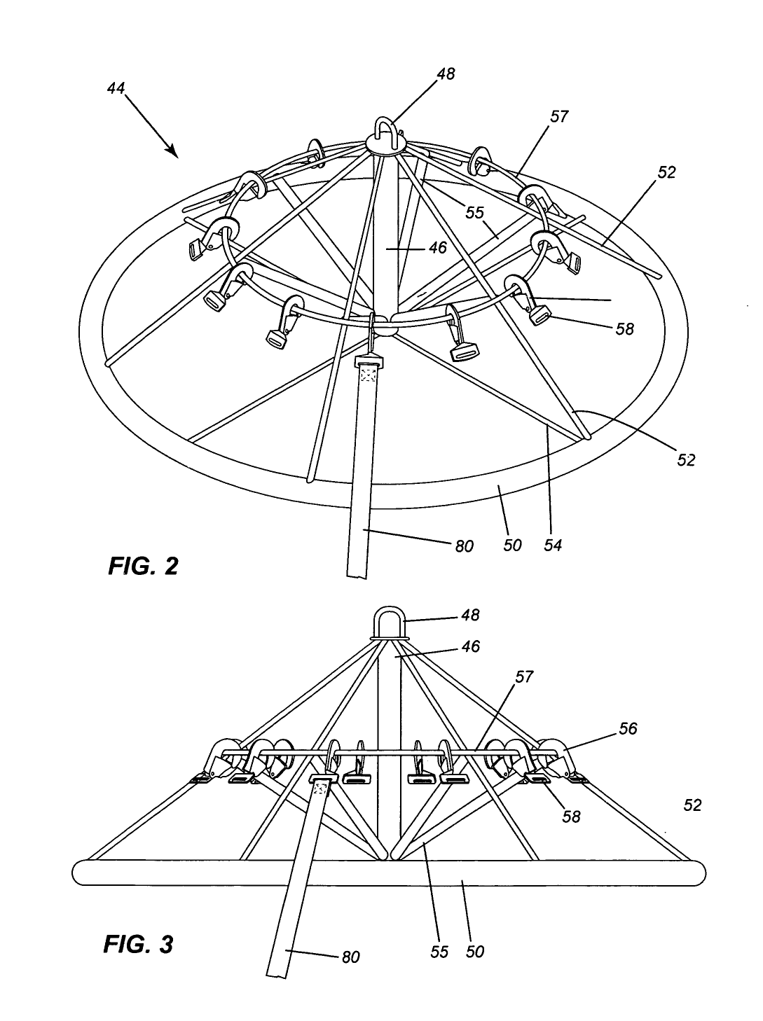

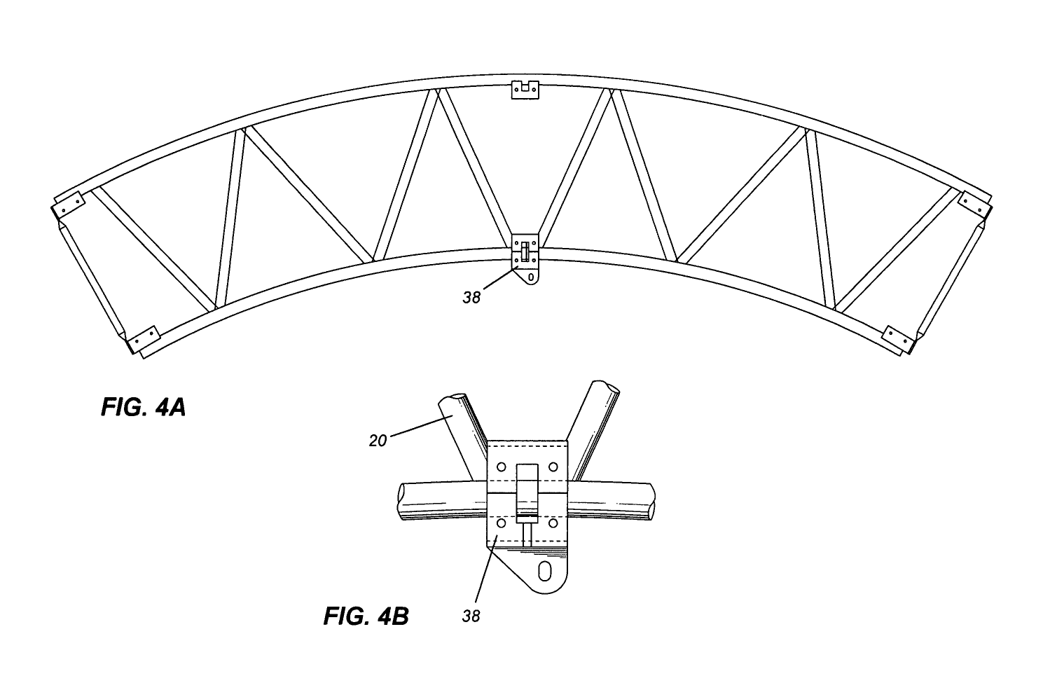

An upper connecting device structure is generally designated by reference numeral 44 and is best seen in FIG. 2. Upper connecting device 44 includes a vertical post 46 having each strap to tighten the same.

The containment structure Will also preferably include an access opening in a lower portion of the cover in order to provide access to the contents of the septic pit when desired for removal of portions of the contents thereof.

### BRIEF DESCRIPTION OF THE DRAWINGS

Having thus generally set forth the aims of the invention, reference will now be made to the accompanying drawings illustrating an embodiment thereof, in which:

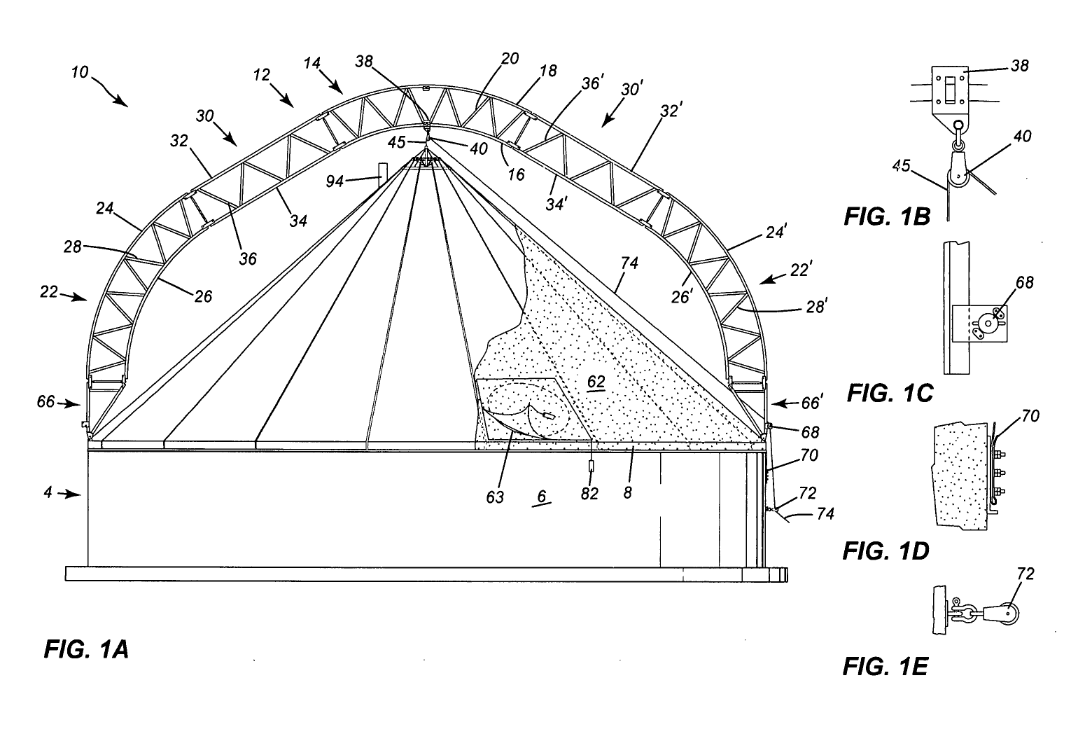

FIG. 1A Is a side elevational view of a containment structure according to one embodiment of the present invention;

FIGS. 1B, 1C, 1D and 1E are side views of certain elements of the structure seen in FIG. 1;

FIG. 2 is a perspective view of the top structure supporting the cover;

FIG. 3 is a side elevational view thereof;

FIG. 4A shows an upper portion of the truss;

FIG. 4B is an enlarged view of the plate member of FIG. 4A;

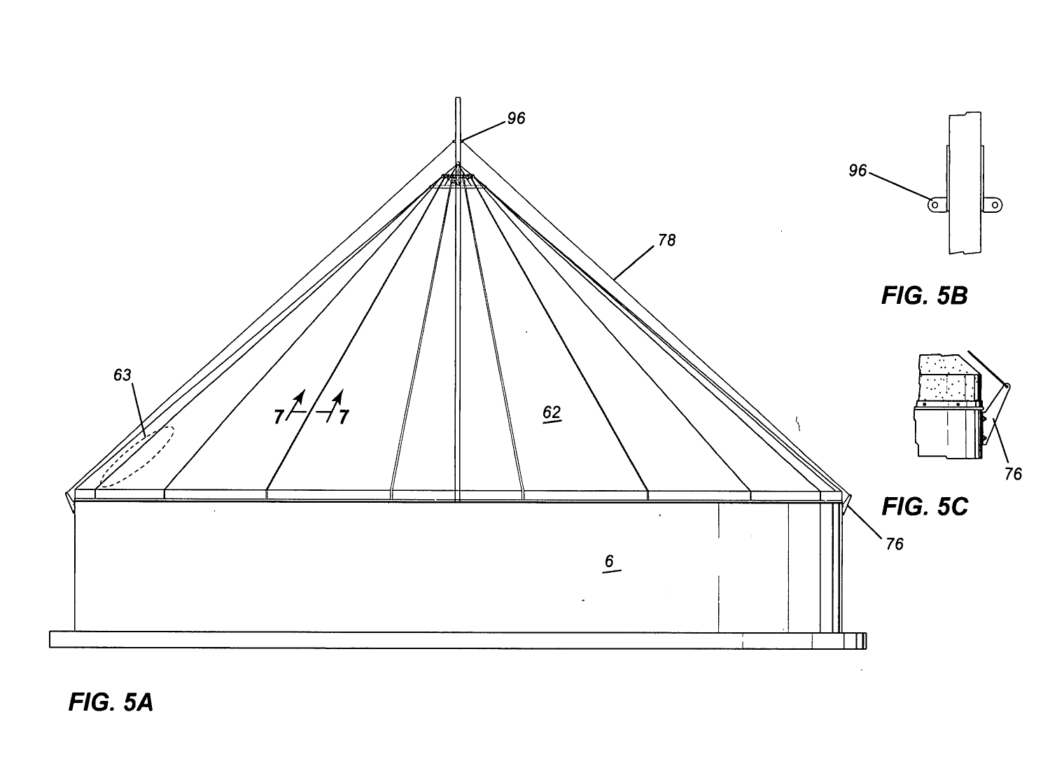

FIG. 5A is a side elevational view seen from the right hand side of FIG. 1;

FIG. 5B is an enlarged view of the upper portion of the cover;

FIG. 5C is an enlarged view of the bracket on the side of the septic pit;

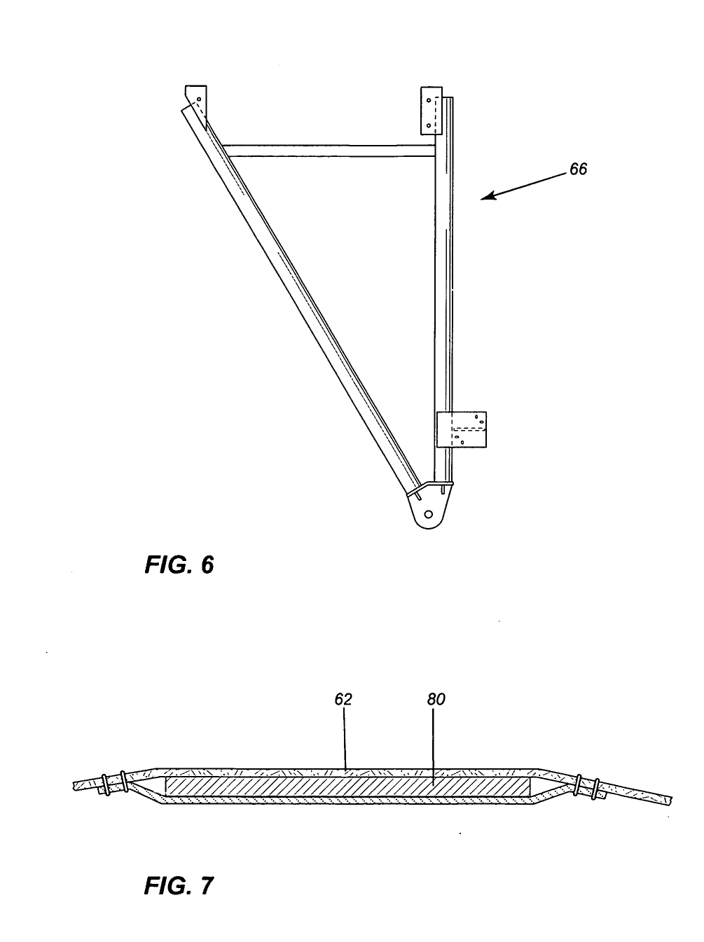

FIG. 6 illustrates various views of the components of the cover structure; and

FIG. 7 is a cross sectional view of a strap structure.

a half ring 48 mounted on top thereof to receive a flexible cable 45 connected to pulley 40. The structure further includes a bottom ring 50 having a plurality of struts 52 extending therefrom and connecting to an upper end of vertical post 46. Other struts 54 extend between bottom ring 50 and the bottom of vertical post 46. Still further struts 55 extend between an upper ring 57 and struts 52. A plurality of retainers 56 having openings 58 thereon are mounted on upper ring 55. A cover 62 is supported by upper support structure 44. Cover 62 includes an access opening 63.

At either end of end sections 22, 22′ there is provided a support structure 66, 66′ which is best seen in FIG. 6.

As shown in FIG. 1B, a pulley 68 is mounted on the side of support structure 66′. Mounted below pulley 68 is a locking plate 70 and a further pulley 72. A cable 74 extends from bracket 95 through the pulleys.

A pair of brackets 76 may be mounted on side wall 6 of the septic pit and a cable 78 may be entrained thereabout.

A plurality of straps 80 provide the support for cover 62. Each strap 80 is secured through openings 58 of retainers 56 and extend downwardly to lower attachment members 82. Lower attachment members 82 may be in the form of a winch to assist in the tightening of straps 80. As shown in FIG. 7, each strap 80 is encased within cover 62. Many different arrangements may be utilized with mechanical fasteners and/or welding of the material.

A chimney 94 is provided to permit the removal of gas such as methane to be burned.

It will be understood that the above described embodiments are for purposes of illustration only and that changes and modifications may be made thereto without departing from the spirit and scope of the invention.

I claim:

1. A containment structure for a septic pit for manure, said septic pit having a side wall extending upwardly from a bottom wall, said containment structure comprising:
a base designed to sit on said sidewall of said septic pit;
a frame extending over said septic pit;
an upper connecting device, said upper connecting device hanging from a flexible cable interconnecting said upper connecting device and said frame;
a plurality of lower attachment members;
a plurality of straps extending between said upper connecting device and said lower attachment members; and
a cover extending over said septic tank, said cover being supported by said straps.

2. The containment structure of claim 1 wherein said straps are encased within said cover.

3. The containment structure of claim 2 wherein said upper connecting device includes a ring, said ring having a plurality of strap attachment members secured thereto.

4. The containment structure of claim 1 further including a plurality of winches mounted proximate said lower attachment members.

5. The containment structure of claim 1 further including an access opening in a lower portion of said cover.

6. The containment structure of claim 1 further including a chimney structure located within an upper portion of said cover.

7. The containment structure of Claim further including a pulley located at each of said lower attachment members.
